(19) United States
(12) Patent Application Publication
(10) Pub. No.: US 2012/0037191 A1
(43) Pub. Date: Feb. 16, 2012

(54) CLEANING SEQUENCE FOR OXIDE QUALITY MONITORING SHORT-LOOP SEMICONDUCTOR WAFER

(75) Inventors: Liang Chun Sung, Changhua County (TW); Jhong Zhong Chen, Zhubei (TW); Kai Yao Chang, Yunlin County (TW); Yuan Pu Liao, Hsimchu (TW); Chia Jung Yang, Hsinchu County (TW); Wei Ming Chen, Hsimchu (TW)

(73) Assignee: MACRONIX INTERNATIONAL CO., LTD., Hsinchu (TW)

(21) Appl. No.: 12/857,104

(22) Filed: Aug. 16, 2010

(51) Int. Cl. B08B 3/00

(52) U.S. Cl. 134/28

(57) ABSTRACT

Disclosed herein are methods for novel cleaning processes for inline quality monitoring short-loop semiconductor wafers. In one embodiment, an exemplary process may comprise immersing the short-loop wafer in an SC-2 aqueous solution comprising hydrochloric acid and hydrogen peroxide at a temperature of about 60° C., and for a time period of about 600 seconds, and then rinsing the wafer with deionized water to remove residual SC-2 solution immediately following immersing the wafer in the SC-2 solution. This exemplary method may then comprise immersing the short-loop wafer in an SC-1 aqueous solution comprising ammonia and hydrogen peroxide immediately after rinsing the wafer to remove residual SC-2 solution, and then rinsing the wafer with deionized water to remove residual SC-1 solution immediately following immersing the wafer in the SC-1 solution. In such a method, however, the wafer is immersed in an HF aqueous solution comprising hydrofluoric acid immediately prior to immersing the wafer in the SC-2 solution, or immediately after immersing the wafer in the SC-1 solution.

### BACKGROUND

1. Technical Field

The present application relates to quality monitoring for impurities on semiconductor wafer during the manufacturing process, and more particularly to novel cleaning processes for inline quality monitoring short-loop semiconductor wafers.

2. Related Art

In the face of increased competition in the market, shortening the development time of products is highly important. However, semiconductor manufacturing processes may take weeks to complete the manufacture of a semiconductor wafer product, and thus weeks before a complete test of electrical characteristics for judging whether devices are good or not may be performed. Naturally, if defects in the manufacturing process are found, much time has been lost before learning that the process(es) must be modified. In order to eliminate the need to wait until complete wafers are produced, short-loop monitoring processes are often implemented for measuring defects during the manufacturing process, or “in-line,” and thereby the quality of the semiconductor manufacturing process can be controlled along the way. As such, a short-loop device is a device which has a short turn-around time and can produce the desired test results quickly. Such short-loop monitoring enables the identification of defect during the overall manufacturing process, which leads to using fewer processing steps and saving time for process defect detection.

While short-loop processing has gained popularity throughout the semiconductor manufacturing marketplace, even efficient short-loop monitoring fails the quality control process if the short-loop devices themselves include harmful defects. One of the key areas where defects can affect the quality of short-loop devices is in the wafer cleaning processes used in the manufacturing of a short-loop device. However, as semiconductor feature geometries continue to shrink and die sizes grow, microcontaminants, such as particles, metallic impurities, native oxides, and trace organic contaminants, have an ever-increasing detrimental impact on device quality and reliability. Every semiconductor wafer processing step in ULSI manufacturing is a potential source of such contaminants may lead to defect formation. Accordingly, scrupulous cleaning of short-loop wafer surfaces is essential to maintain quality standards, and thus obtain high device yields for completed wafers.

In particular, rigorous “wet cleaning” is known to be effective in reducing the presence of these contaminants on the wafer surface, making it typically the most frequently repeated step in any large-scale integration (LSI) manufacturing sequence. For typical semiconductor wafer cleaning, hydrogen peroxide-based chemistry (H₂O₂) is the most prevalent cleaner in the semiconductor industry worldwide. Most notably, it is used to perform chemical wet-cleaning on wafers, in which semiconductor wafers are sequentially immersed for several minutes in a specific wet cleaning sequence. Specifically, the wafer are first immersed for several minutes in an NH₄OH—H₂O₂—H₂O mixture (known as “SC-1” mixture in the industry), and then in an HCl—H₂O₂—H₂O mixture (known as “SC-2”) at elevated temperatures. Third, the wafers are immersed in diluted hydrofluoric acid (HF) at room temperature. As a result, this conventional wet cleaning process has a sequence of:

SC-1→SC-2→HF

In alternative conventional wet cleaning sequences, the hydrofluoric acid immersion at room temperature is conducted at the beginning of the cleaning process, rather than at the end. Such an approach is often used in conventional techniques for the removal specifically of oxide-based impurities. Thus, this conventional wet cleaning process has a sequence of:

HF→SC-1→SC-2

In such immersion-type wet chemical cleans, even if ultra-pure chemicals are introduced and then disposed of after each wafer-cleaning treatment, contaminant-removal efficiency is still compromised by impurities brought into the fresh solution by incoming wafers. In addition, employing an SC-2 chemical solution immediately after an SC-1 chemical immersion often results in ineffective monitoring of wafers during the manufacturing process due to the low quality of the external oxide layer remaining on the short-loop wafer after being cleaned with the conventional chemical cleaning sequence.

In order to meet increasingly stringent wafer-cleanliness requirements, new cleaning methods are often developed; however, these are all typically still based on conventional wet cleaning sequences, and only techniques for decreasing the introduction of contaminants are typically explored. One conventional attempt at reducing new contaminant introduction includes single-wafer spin cleaning, in which fresh chemicals are continuously supplied to the wafer. If single-wafer spin cleaning is used in the wet etching of films on silicon substrates, better etch uniformity is expected from wafer to wafer and lot to lot. Unfortunately, such approaches, while often successful in reducing contamination in the wet cleaning process, are typically better suited for single-wafer cleaning techniques. As a result, the single-wafer spin cleaning equipment's throughput is significantly lower than immersion-based multi-wafer set-ups. Moreover, cost is often increased due to increased chemical consumption, and thus alternative cleaning chemicals, which often are not as effective, are needed in order to reign in costs.

Accordingly, in view of the above, it would be desirable to find alternative approaches for large volume wet cleaning processes for semiconductor wafers that successfully clean substantially all of the metallic and organic contaminants from the wafers, but that does not suffer from the deficiencies found in the conventional approaches.

### SUMMARY

Disclosed herein are methods for wet cleaning process for short-loop wafer used in the monitoring of tunnel oxide layers in manufactured wafers. A short-loop wafer manufactured according to the disclosed principles has an additional exterior oxide surface remaining on the top of the tunnel oxide layer. This upper oxide surface is the result of the specific chemical process flow disclosed herein, and does not remain on the tunnel oxide layer's exterior surface when the above-described conventional chemical sequence for creating short-loop monitoring wafers is employed. The upper oxide surface on the tunnel oxide layer allows for better short-loop monitoring of tunnel oxide layer formation on manufactured wafers.

In one embodiment, a method of wet-cleaning a semiconductor wafer in accordance with the disclosed principles comprises cleaning the wafer with an SC-2 aqueous solution comprising hydrochloric acid and hydrogen peroxide, and then cleaning the wafer with an SC-1 aqueous solution comprising ammonia and hydrogen peroxide after cleaning the wafer with the SC-2 solution. Such an exemplary method may then comprise cleaning the wafer with an HF aqueous solution comprising hydrofluoric acid after cleaning the wafer with the SC-1 solution.

In another embodiment of a method of wet-cleaning a semiconductor wafer in accordance with the disclosed principles, the method could comprise first cleaning the wafer with an HF aqueous solution comprising hydrofluoric acid. This exemplary method could then comprise cleaning the wafer with an SC-2 aqueous solution comprising hydrochloric acid and hydrogen peroxide after cleaning the wafer with the HF solution, and then cleaning the wafer with an SC-1 aqueous solution comprising ammonia and hydrogen peroxide after cleaning the wafer with the SC-2 solution.

In yet another embodiment of a method of wet-cleaning a semiconductor wafer in accordance with the disclosed principles, the method may comprise immersing the short-loop wafer in an SC-2 aqueous solution comprising hydrochloric acid and hydrogen peroxide at a temperature of about 60° C., and for a time period of about 600 seconds, and then rinsing the wafer with deionized water to remove residual SC-2 solution immediately following immersing the wafer in the SC-2 solution. This exemplary method may then comprise immersing the short-loop wafer in an SC-1 aqueous solution comprising ammonia and hydrogen peroxide immediately after rinsing the wafer to remove residual SC-2 solution, and then rinsing the wafer with deionized water to remove residual SC-1 solution immediately following immersing the wafer in the SC-1 solution. In such a method, however, the wafer is immersed in an HF aqueous solution comprising hydrofluoric acid immediately prior to immersing the wafer in the SC-2 solution, or immediately after immersing the wafer in the SC-1 solution.

It should be understood that both the foregoing general description and the following detailed description are exemplary, and are not intended to limit the scope of the invention.

### BRIEF DESCRIPTION OF THE DRAWINGS

Features, aspects, and embodiments of the inventions are described in conjunction with the attached drawings, in which:

FIG. 1 illustrates a cross-sectional view of a portion of a semiconductor wafer after undergoing a conventional cleaning sequence;

FIG. 2 illustrates a flow diagram of an exemplary cleaning process conducted in accordance with the disclosed principles; and

FIG. 3 illustrates a cross-sectional view of a portion of a semiconductor wafer after undergoing a cleaning sequence conducted in accordance with the principles disclosed herein.

### DETAILED DESCRIPTION

As is known in the technology field of the present disclosure, during semiconductor wafer manufacturing processing, including the formation of oxide-based features and dielectric layers, wafers typically undergo a cleaning process for removing impurities and other particles from the wafer surfaces. This particulate contamination problem is a crucial one, particularly in the manufacture of new generation devices with line widths or feature sizes, for example, in the 0.05 to 0.10 micron range, or gate oxide thicknesses in the range of 10 to 20 angstroms.

Exemplary cleaning processes, such as the sequences discussed above, include an SC-1 solution immersion or washing of the wafer, followed by an SC-2 solution immersion or washing of the wafer. In addition, a diluted HF solution immersion may be employed before the SC-1→SC-2 cleaning process, or immediately following that cleaning sequence. During such a cleaning sequence, the SC-1 solution removes particles from the wafer surface. More specifically, the higher alkaline SC-1 chemical solution affects the SiO₂ underneath particles on the wafer surface, which allows the particles to more easily removed from the surface of the wafer. The SC-2 solution, however, tends to add particles to the wafer surface. Specifically, the electrical attraction of particles to the wafer surface typically causes particles to become attracted to the surface of the wafer.

Thus, conventional approaches, even those incorporating sonic systems, have been unsuccessful in removing or eliminating sub 0.1-micron particles, which in view of the feature sizes mentioned above can destroy the functionality of the manufactured semiconductor devices. Moreover, as feature sizes decrease, the forces of attraction between these tiny features and sub 0.1-micron particles become increasingly difficult to overcome. In addition, with regard to the SC-1 solution, because of the ammonia in the chemical make-up of this type of solution also etches away silicon, surface roughness on the wafer can be an undesired affect of the cleaning process. Still further, during the SC-1 cleaning process, the NH₄OH tends to form NH₄OH vapor over the surface of the SC-1 cleaning solution. Thus, when the wafer is removed from the SC-1 cleaning solution, NH₄OH vapor attacks the clean wafer surface, i.e., the fresh silicon surface of the wafer. Consequently, a defect known as “silicon hole” frequently occurs wherein craters in the silicon surface are formed due to the NH₄OH vapor attack.

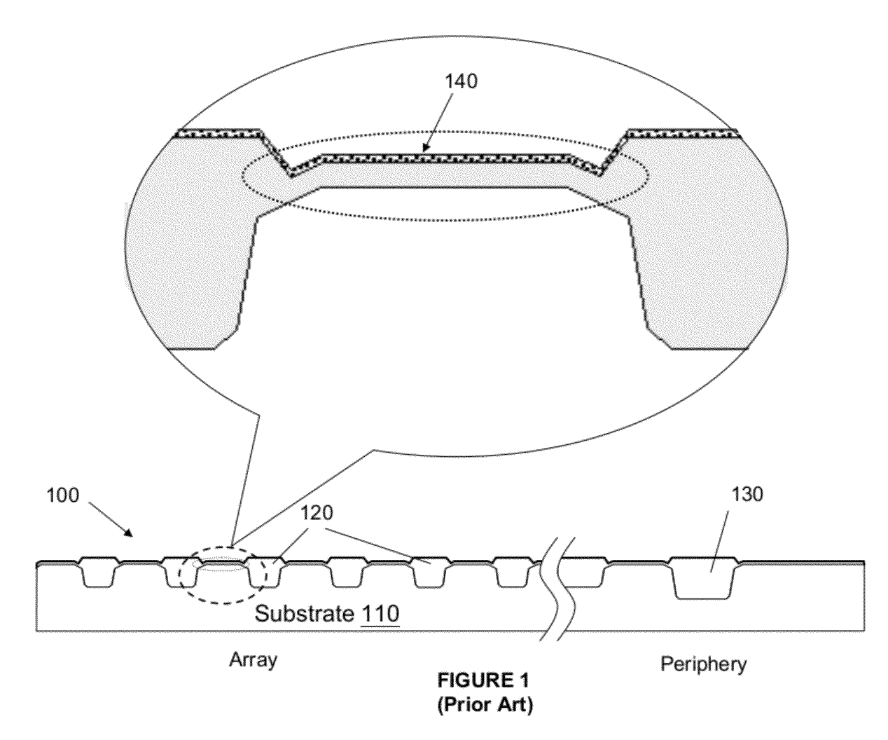

FIG. 1 illustrates a cross-sectional view of a portion of a semiconductor wafer 100 after undergoing such a conventional cleaning process. Because of the etching and other detrimental effects of the conventional wafer cleaning process(es) discussed above, the manufacture of in-line short-loop wafers for monitoring oxide quality control using the same conventional cleaning process can be particularly impacted. For example, as can be seen in FIG. 1, the wafer 100 includes an upper dielectric oxide (tunnel oxide) layer 120 formed in the array region of the substrate 110, and an STI isolation region 130 formed in the periphery region of the substrate 110. As shown in the close-up view of the upper oxide layer 120, the top surface of the oxide layer 120 has a residual oxide layer 140 caused by the conventional cleaning processes, which leaves the oxide layer 120 with chemical impurity damage. This can cause oxide isolation function failing in production wafers due to leakage induced by oxide quality degrading during manufacturing, based on the use of the conventional short-loop wafer 100 for oxide quality monitoring. As a result of such defects in the wafer, oxide breakdown (charge to breakdown; test dielectric oxide endurance) or high leakage current can occur in the finished device(s). Thus in sum, dielectric oxide strength and endurance performance degrade effective monitoring of wafer oxides when an SC-2 chemical solution is used after employing an SC-1 chemical solution on short-loop test wafers.

In order to overcome the deficiencies associated with and caused by the conventional approaches discussed above, a new sequence for the wet-cleaning of short-loop wafers used for in-line monitoring of oxide quality is disclosed herein. Specifically, the disclosed principles involve the reversal of cleaning steps in a wet-cleaning chemical process. Thus, the disclosed technique involves performing an SC-2 solution chemical cleaning prior to performing an SC-1 solution chemical cleaning, which is contrary to the sequence employed by conventional wet-cleaning processes. In addition, an HF solution cleaning may be performed prior to the SC-2 cleaning step, or after the SC-1 cleaning step.

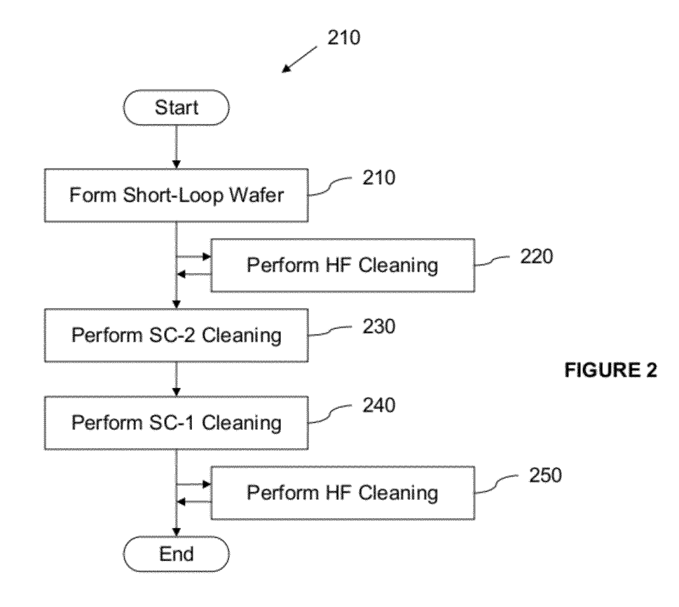

Looking now at FIG. 2, illustrated is a flow diagram 200 of an exemplary cleaning process conducted in accordance with the disclosed principles. The process begins, at a Step 210, with the manufacture of a short-loop semiconductor wafer. In exemplary embodiments, the short-loop wafer may be a test wafer for in-line testing of oxide quality of a portion of the overall manufacturing process of a semiconductor wafer of IC dies. For example, the short-loop wafer may be used for testing the oxide quality resulting from a shallow trench isolation (STI) manufacturing process.

Next in the process, in one embodiment, the disclosed process may begin the cleaning sequence, at a Step 220, with a cleaning solution that includes hydrogen fluoride or hydrofluoric acid (HF). With the HF solution, the oxide-base impurities are removed from the short-loop wafer. An exemplary chemical concentration for the diluted HF solution may be 49%. Also, exemplary embodiments process the wafer using the diluted HF solution at a temperature range of about 30° C., and for a processing time of about 155 seconds. Moreover, in some embodiments, the cleaning with the HF chemical solution may be done via wafer immersion in a solution tank. In other embodiments, the HF cleaning may be performed using an alternative process. Regardless of the technique, the wafer is then rinsed to remove residual HF solution.

Whether the disclosed exemplary wafer cleaning process begins with an HF cleaning process, the disclosed wafer cleaning process move to a Step 230, wherein the short-loop wafer is cleaned using a chemical solution that includes ammonia and hydrogen peroxide (commonly referred to as an SC-2 chemical solution). As with the HF cleaning, in some embodiments, the cleaning with the SC-2 solution may be done via wafer immersion in a solution tank. In other embodiments, the SC-2 cleaning may be performed using an alternative process. With the SC-2 solution, the surface metal ion impurity is removed from the surface of the short-loop test wafer.

In an exemplary embodiment, the SC-2 solution comprises about 1.5% HCl. In advantageous embodiments, a specific solution concentration of 1-5% may be selected for the SC-2 solution. This results in a chemical ratio of about 80 (H₂O): 1.3 (HCl): 2.2 (H₂O₂). Exemplary temperatures for the SC-2 solution immersion may be kept at between 70° C. and 80° C. In addition, exemplary immersion times for cleaning in the SC-2 solution may be about 10-15 min. After the SC-2 cleaning is completed, the wafer is then rinsed to remove residual SC-2 solution using DI water. For example, the wafer may again be immersed in the rinse tank of DI water to remove the residual SC-2 solution. Exemplary time in the rinse tank may be about 10 minutes or more, and may be conducted at room temperatures.

After rinsing the residual SC-2 solution, the disclosed process moves to a Step 240, where the wafer undergoes cleaning with a solution that includes hydrochloric acid (HCl) and hydrogen peroxide (commonly referred to as an SC-1 chemical cleaning solution). In some embodiments, the time required for cleaning in the SC-1 solution may be similar to the time employed with the SC-2 solution, which is about 640 sec. Since typically SC-1 solution etches silicon oxide at a rate of about 10 Å/hr when conducted at a temperature of about 50° C., in an exemplary embodiment of the disclosed principles the wafer may be processed using an SC-1 solution at a temperature range of about 50° C., and for a processing time of about 640 sec. Moreover, in advantageous embodiments, a specific solution concentration of 1-5% may be selected for the SC-1 solution.

More specifically, because the ammonia in the SC-1 solution can cause undesired surface roughness as mentioned above, advantageous embodiments may have a higher concentration of hydrogen peroxide to prevent the ammonia from producing undesirable roughening. This results in a chemical ratio of about 80 (H₂O):2.2 (NH₄OH):3.1 (H₂O₂). After the SC-1 cleaning is completed, the wafer is moved to the second rinse tank for removing any residual SC-1 cleaning solution, again by DI water. Exemplary time in the second rinse tank may be about over 10 min, and may also be conducted at room temperatures.

Following the rinse of residual SC-1 chemical cleaning solution, if the wafer was not initially cleaned with an HF solution, the disclosed process may then move to a Step 250, where the wafer is cleaned with an HF solution. In embodiments where the wafer is cleaned with an HF solution following cleaning with the SC-1 solution, this results in the removal surface particle and organic-base impurity. As mentioned above, an exemplary solution concentration for the diluted HF solution may be 49%. Also, exemplary embodiments process the wafer using the diluted HF solution at a temperature range of about 30° C., and for a processing time of about 155 seconds.

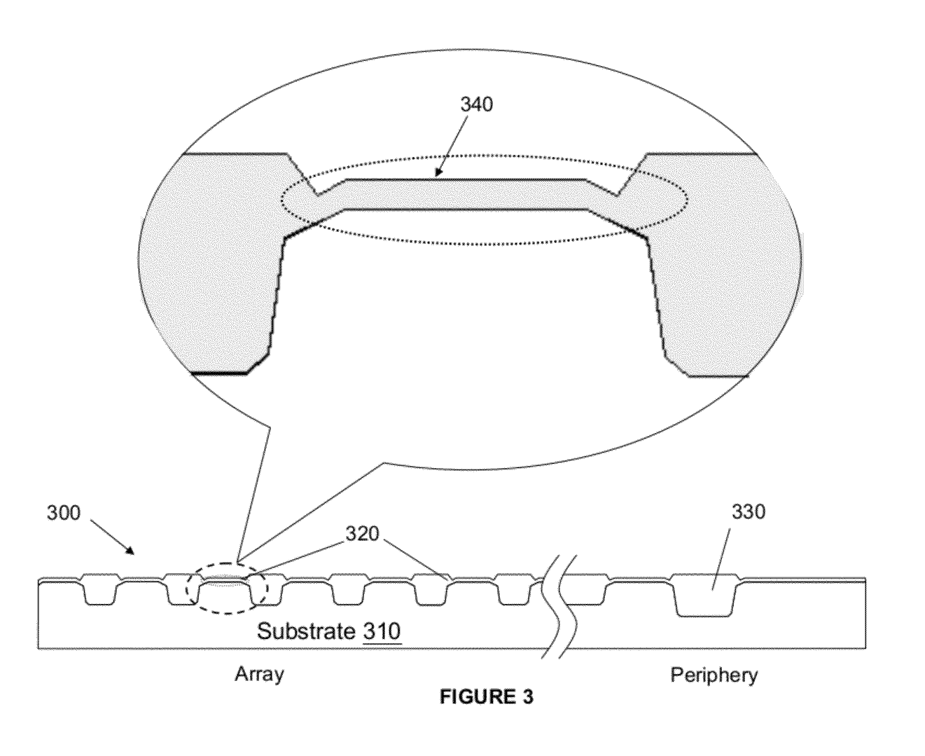

Turning now to FIG. 3, illustrated is a cross-sectional view of a portion of a short-loop semiconductor wafer 300 after undergoing a cleaning sequence conducted in accordance with the principles disclosed herein. As can be seen in FIG. 3, a short-loop wafer cleaned according to an embodiment of the disclosed principles has higher sensitivity to detecting dielectric oxide quality degradation in processed wafers because of the reduction in impurities provided by the disclosed chemical cleaning process. Specifically, the wafer 300 includes a dielectric oxide (tunnel oxide) layer 320 formed in the array region of the substrate 310, and an STI isolation region 330 formed in the periphery region of the substrate 310. However, the short-loop wafer 300 of FIG. 3 that has been manufactured according to the disclosed principles differs from the final short-loop wafer 100 in FIG. 1 by not having the residual oxide surface 140 (shown in FIG. 1) left by conventional cleaning processes on the top of the tunnel oxide layer 320.

In conventional cleaning processes, such as those discussed above, the exterior surface of the tunnel oxide layer 320 was left damaged. Specifically, the impurities of the cleaning chemicals in the conventional cleaning sequence induced a low quality to the exterior surface of the tunnel oxide, which results in the residual oxide layer 140 remaining on wafer cleaned with the conventional approach. In contrast, the upper surface of the oxide layer 320 is undamaged as the result of the specific chemical cleaning sequence disclosed herein. For example, the exterior oxide surface typically pits or has an otherwise bad uniformity after performing the conventional chemical cleaning sequence. Also, impurities (such as metal ion particles) often remain on the oxide surface, resulting in surface defects. Since the short-loop wafer is used for monitoring oxide quality on manufactured wafers during the manufacturing process, any particles (abnormal impurities) not removed during the cleaning sequence can result in the allowance of low quality oxides in manufactured wafers. In contrast, by using the disclosed chemical cleaning sequence, oxide surface damage/defects (which effect oxide quality) typically remaining from the conventional cleaning process(es) used on short-loop wafers are substantially removed. Indeed, the intentional alteration of the chemical cleaning sequence, which is contrary to conventional practices, is selected such that the upper oxide surface 140 does not remain on the tunnel oxide layer 320. The remaining high-quality (i.e., low defect/impurities) oxide surface on the exterior surface of the tunnel oxide layer 320 results in more effective monitoring against chemical impurity damage and defects on the tunnel oxide layers in production wafers, which is sustained when manufactured wafers are cleaned using the conventional chemical cleaning processes. Accordingly, the disclosed cleaning sequence for the short-loop monitoring wafer provides increased oxide layer quality in production wafers cleaned with conventional processes because it allows for better short-loop monitoring of tunnel oxide layer formation on manufactured wafers.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of wet-cleaning a semiconductor wafer, the method comprising:
cleaning the wafer with an SC-2 aqueous solution comprising hydrochloric acid and hydrogen peroxide;
cleaning the wafer with an SC-1 aqueous solution comprising ammonia and hydrogen peroxide after cleaning the wafer with the SC-2 solution; and
cleaning the wafer with an HF aqueous solution comprising hydrofluoric acid after cleaning the wafer with the SC-1 solution.

2. A method according to claim 1, wherein the cleaning each comprises immersing the wafer.

3. A method according to claim 1, wherein the wafer is an in-line short-loop semiconductor wafer.

4. A method according to claim 1, wherein the SC-2 solution comprises HCl, H₂O₂, H₂O.

5. A method according to claim 1, wherein cleaning the wafer with the SC-2 solution comprises cleaning the wafer with the SC-2 solution at a temperature of about 60° C., and for a time period of about 600 seconds.

6. A method according to claim 1, wherein the SC-1 solution comprises NH₄, OH, H₂O₂, H₂O.

7. A method according to claim 1, wherein cleaning the wafer with the SC-1 solution comprises cleaning the wafer with the SC-1 solution at a temperature of about 50° C., and for a time period of about 640 seconds.

8. A method according to claim 1, further comprising rinsing the wafer with deionized water immediately following cleaning the wafer with the SC-2 solution, and further rinsing the wafer with deionized water immediately following cleaning the wafer with the SC-1 solution.

9. A method according to claim 1, wherein cleaning the wafer with the HF solution comprises cleaning the wafer with the HF solution at a temperature of about 30° C., and for a time period of about 155 seconds.

10. A method of wet-cleaning a semiconductor wafer, the method comprising:
cleaning the wafer with an HF aqueous solution comprising hydrofluoric acid;
cleaning the wafer with an SC-2 aqueous solution comprising hydrochloric acid and hydrogen peroxide after cleaning the wafer with the HF solution; and
cleaning the wafer with an SC-1 aqueous solution comprising ammonia and hydrogen peroxide after cleaning the wafer with the SC-2 solution.

11. A method according to claim 10, wherein the cleaning each comprises immersing the wafer.

12. A method according to claim 10, wherein the wafer is an in-line short-loop semiconductor wafer.

13. A method according to claim 10, wherein the SC-2 solution comprises HCl, H₂O₂, H₂O.

14. A method according to claim 10, wherein cleaning the wafer with the SC-2 solution comprises cleaning the wafer with the SC-2 solution at a temperature of about 60° C., and for a time period of about 600 seconds.

15. A method according to claim 10, wherein the SC-1 solution comprises NH₄, OH, H₂O₂, H₂O.

16. A method according to claim 10, wherein cleaning the wafer with the SC-1 solution comprises cleaning the wafer with the SC-1 solution at a temperature of about 50° C., and for a time period of about 640 seconds.

17. A method according to claim 10, further comprising rinsing the wafer with deionized water immediately following cleaning the wafer with the SC-2 solution, and further rinsing the wafer with deionized water immediately following cleaning the wafer with the SC-1 solution.

18. A method according to claim 10, wherein cleaning the wafer with the HF solution comprises cleaning the wafer with the HF solution at a temperature of about 30° C., and for a time period of about 155 seconds.

19. A method of wet-cleaning a semiconductor wafer, the method comprising:
immersing the wafer in an SC-2 aqueous solution comprising hydrochloric acid and hydrogen peroxide at a temperature of about 60° C., and for a time period of about 600 seconds;
rinsing the wafer with deionized water to remove residual SC-2 solution immediately following immersing the wafer in the SC-2 solution;
immersing the wafer in an SC-1 aqueous solution comprising ammonia and hydrogen peroxide immediately after rinsing the wafer to remove residual SC-2 solution;
rinsing the wafer with deionized water to remove residual SC-1 solution immediately following immersing the wafer in the SC-1 solution;
wherein the wafer is immersed in an HF aqueous solution comprising hydrofluoric acid immediately prior to immersing the wafer in the SC-2 solution, or immediately after immersing the wafer in the SC-1 solution.

20. A method according to claim 19, wherein the wafer is an in-line short-loop semiconductor wafer.
